(19) United States
(12) Patent Application Publication
(10) Pub. No.: US 2019/0334785 A1
(43) Pub. Date: Oct. 31, 2019

(54) FORECASTING UNDERUTILIZATION OF A COMPUTING RESOURCE

(71) Applicant: Microsoft Technology Licensing, LLC, Redmond, WA (US)

(72) Inventors: Russell A. Penar, Highlands Ranch, CO (US); Amer A. Hassan, Kirkland, WA (US); Ronald F. Johnson, Kirkland, WA (US)

(21) Appl. No.: 15/963,804

(22) Filed: Apr. 26, 2018

(51) Int. Cl. H04L 12/24; H04L 12/801

(52) U.S. Cl. CPC H04L 41/147; H04L 43/0876; H04L 47/10; H04L 41/142

(57) ABSTRACT

Methods and systems disclosed designate a first network for a first class of traffic and a second network for a second class of traffic. An event may be forecast that indicates utilization of the second network over a future period of time. Based on the forecast event, the designation of the second network for the second class of traffic may be overridden such that the first class of traffic is also sent over the second network.

### BACKGROUND

Computer networks may be designed to meet the needs of a target customer. For example, networks designed to deliver consumer traffic may focus on providing cost effective communications, while tolerating a certain level of jitter, latency, reliability, and throughput. Networks designed for enterprise traffic may have different design constraints. For example, enterprise customers demand high reliability as the business of many enterprise customers simply cannot function effectively during a network outage. Enterprise customers may also place more importance on certain network applications, such as video conferencing, which may require lower latency and jitter, while also delivering high throughput, especially for high definition video conferences.

Many enterprise customers define certain service levels that must be met by a network provider. These service levels may be specifically identified in contracts supporting a relationship between the enterprise customer and the network provider. To ensure these service levels are met, network providers may manage utilization of their enterprise networks to ensure adequate capacity to service network traffic as needed. During periods of low utilization, network providers may be prevented from using their enterprise networks to service other traffic, so as to ensure that service levels for the enterprise networks can be maintained. Thus, improved methods of utilizing networks are desired.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an overview diagram of a system that may implement one or more of the disclosed embodiments

FIG. 2 shows a time series of data that may be analyzed to forecast an event in some aspects of the present disclosed.

FIG. 3 shows multiple time series of data that may be analyzed to forecast an event in some aspects of the present disclosed.

FIG. 4 shows multiple time series of data that may be analyzed to forecast an event in some aspects of the present disclosure.

FIG. 5 is a data flow diagram showing how forecasting of events based on time series data may be provided in some of the disclosed embodiments.

FIG. 6 shows a data flow that may be implemented in at least some of the disclosed embodiments.

FIG. 7 is a flowchart of a method for forecasting an event and overriding a designation of a first network based on the forecast event.

FIG. 8 is a flowchart of a method of determining whether to override a designation of a network for a particular class of traffic, that may be implemented in at least some of the disclosed embodiments.

FIG. 9 is a flowchart of a method for forecasting an event that may be implemented in some of the disclosed embodiments.

FIG. 10 illustrates a block diagram of an example machine upon which any one or more of the techniques discussed herein may perform.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

As discussed above, computing resources, such as computer networks, may be designated to perform certain types of tasks based on their capabilities. For example, high quality and performant networks may be designated to service enterprise customers, who typically require high reliability, and low latency, while also being less sensitive to the costs of the service provided. In some cases, service level agreements between network providers and enterprise clients may define strict requirements for service level that must be provided, such as minimum latencies, reliability levels, and the like. Lower cost networks may be designated to service consumer class traffic. Consumers may be typically more cost conscious than enterprises, and thus may tolerate some reduction in performance and/or reliability in order to achieve lower cost.

In some cases, networks may impart a certain fixed cost on a network provider, without the cost incurred being sensitive to network utilization or an amount of traffic carried over the network at any particular time. Thus, even if the network is at a relatively low level of utilization, a cost may be incurred by the network provider that is similar to a cost incurred if the network were more heavily utilized. This lack of proportionality between an amount of network utilization and a cost incurred by the network provider presents a technical problem to the network provider. In particular, for example, a network is designated to service a particular class of traffic, but that particular class of traffic does not result in a cost-effective utilization of the network, the network provider may not be efficiently utilizing the network assets available, resulting in increased expense and decreased profitability for the network provider. Moreover, if that unused network capacity could benefit other customers or classes of traffic but is not available to service this traffic because of the designation, customer satisfaction of those customers may also be reduced.

Thus, the technical problem becomes one of optimizing use of the available resources such as computer networks, while also ensuring that service level agreements with enterprise customers are maintained. One challenge in solving this technical problem is that balancing resource utilization across multiple networks based on current utilization may present too much risk of violating service level agreements with enterprise customers. In an example scenario, enterprise utilization of a first network is temporary low. If only current utilization is considered, other traffic may be routed over the first network to take advantage of the lower utilization. However, in this example scenario, subsequent to the rerouting of other traffic over the first network, demand for the first network by enterprise traffic may increase, resulting in an unsustainable load on the first network due to the combined demands of the enterprise traffic and the other traffic that was previously routed over the first network. If this unsustainable condition results in violation of service level agreements with enterprise customers, undesirable business outcomes could result, including potential contract cancellation in some situations.

The disclosed embodiments provide a technical solution to the technical problems described above, and mitigate against such a scenario by not only considering current utilization of a network, but also a forecast utilization level based on a variety of factors. Some of those factors relate to utilization of the network itself. For example, past utilization over previous hours, days, weeks, months, or even years may be considered when predicting future utilization. As one example, enterprise traffic may be relatively light on national holidays, and such a pattern may repeat over several holidays and/or timeframes. This usage pattern may be used by some embodiments to increase a confidence level that low utilization by enterprise customers may be sustained for some period of time into the future. This may provide for some of the disclosed embodiments to more safety utilize the excess capacity made available by thus relatively predictable pattern of utilization.

Some aspects also reference data external to the network itself to forecast future utilization. For example, usage of some networks may be forecast in some aspects by analyzing one or more of social networking sites, news sites, governmental sites, or other information sources. As one example, a power failure within a certain region may dramatically reduce usage of one or more computer networks servicing that region. Government and/or public utility information sources, such as websites maintained by these organizations, may provide information with respect to when power may be restored. Some embodiments may analyze this information to forecast lower utilization of a network and also when the lower utilization condition may end. This may allow some embodiments to more safely reallocate the unused network capacity while managing any risk of violating service level agreements.

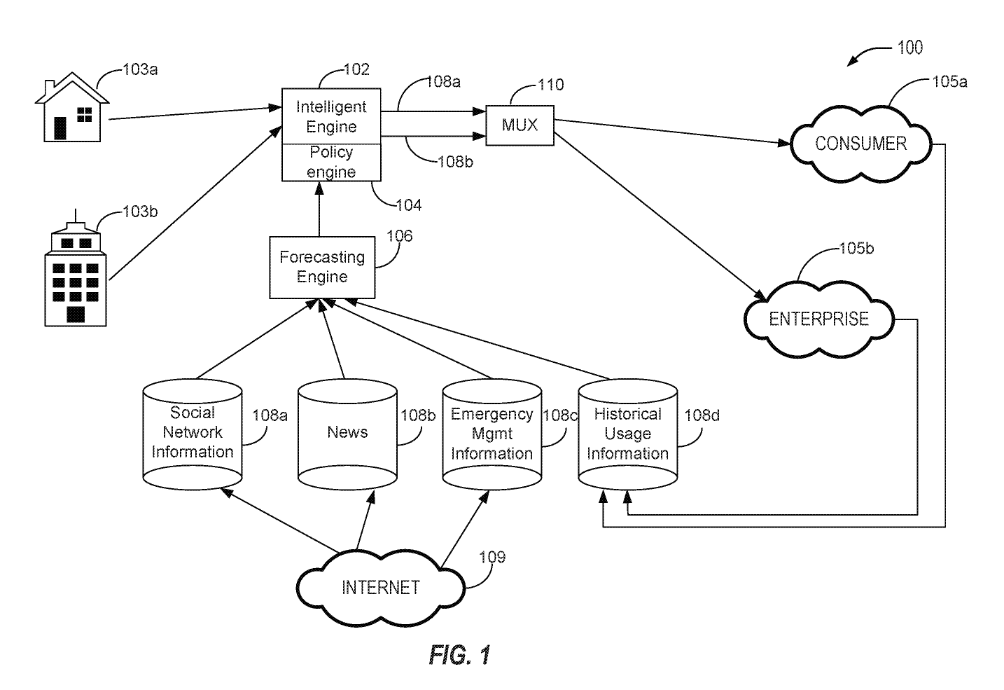

FIG. 1 is an overview diagram of a system that may implement one or more of the disclosed embodiments. The network 100 includes an intelligent engine 102. The intelligent engine 102 receives network data of a first class from a first type of customer 103a. The intelligent engine also receives network data of a second class from a second type of customer 103b. The intelligent engine may include a policy engine 104 that determines how to route the traffic from the first and second type of customers 103a-b over networks 105a-b. The networks 105a-b may be wireless networks, cellular networks, Internet Protocol (IP) networks, Time Division Multiplexing networks, or any combination of network types.

In some aspects, designations within the policy engine 104 may define that traffic from the first type of customer 103a is routed over the network 105a, while traffic from the second type of customer 103b is routed over the network 105b. To accomplish the routing of the traffic from the first type of customer 103a and the second type of customer 103b, the intelligent engine 102 may control a multiplexor 110. The multiplexor 110 may be implemented in a variety of forms. In some aspects, the multiplexor 110 may be a domain name server that maps default gateways for destination IP addresses based on routing decisions made by the policy engine 104 and intelligent engine 102. The multiplexor 110 may receive data 108a and control signals 108b. The control signals 108b may indicate how the multiplexor 110 is to route the data 108a. For example, the control signals 108b may indicate whether the data 108a is to be routed over the first network 105a or the second network 105b.

The system 100 also includes a forecasting engine 106. The forecasting engine 106 may forecast one or more events relating to operation of the network 105a and/or 105b. To forecast the events, the forecasting engine 106 may receive data from one or more of a social network information data store 108a, news information data store 108b, emergency management information data store 108c, and historical usage information data store 108b. The social network information data store 108a, news data store 108b, and emergency management information data store 108c may be populated from data received from the internet 109. For example, some of the disclosed embodiments may implement web crawlers that collect information from one or more destinations on the internet 109 and store the information in the appropriate data store 108a-c. In some aspects, social networking sites, news sites, and/or emergency management sites may provide application programming interfaces (APIs) that enable collection of information that may be used to forecast an event on a network. The emergency management data store 108c may store information relating to, for example, earthquake information, weather information such as blizzards, hurricanes or tornadoes, fire information such as wild fire information, and the like. The historical usage information data store 108d may collect usage information from the networks 105a-b and correlate the information with a time and/or date at which the usage information was collected. While four examples of data stores 180a-d are illustrated in FIG. 1, other types of information are contemplated. For example, in some aspects, data stores including one or more of weather information and electric power availability information are also contemplated. The information in one or more of the data stores 108a-d may be received by the forecasting engine 106. The forecasting engine 106 may then identify one or more patterns or correlations within the information received from the data stores 108a-d to predict or forecast future utilization of one or more of the networks 105a-b.

The policy engine 104 may then use the information provided by the forecasting engine 106 to override one or more designations of traffic received from the customers 103a and/or 103b. For example, if the forecasting engine 106 forecasts that usage of the enterprise network 105b will be low over a holiday weekend, the designation of the second network 105b for traffic from the second type of customer 103b may be overridden to provide for traffic received from the first type of customer 103a to be routed over the network 105b. In some aspects, overriding the designation of the second network (e.g. 105b) may be further conditioned on usage of a first network (e.g. 105a). For example, if a usage measurement of the first network meets one or more criterion, and the forecasting engine 106 forecasts that usage of the a second network (e.g. 105b) will be below a usage threshold, then the designation of the second network may be overridden.

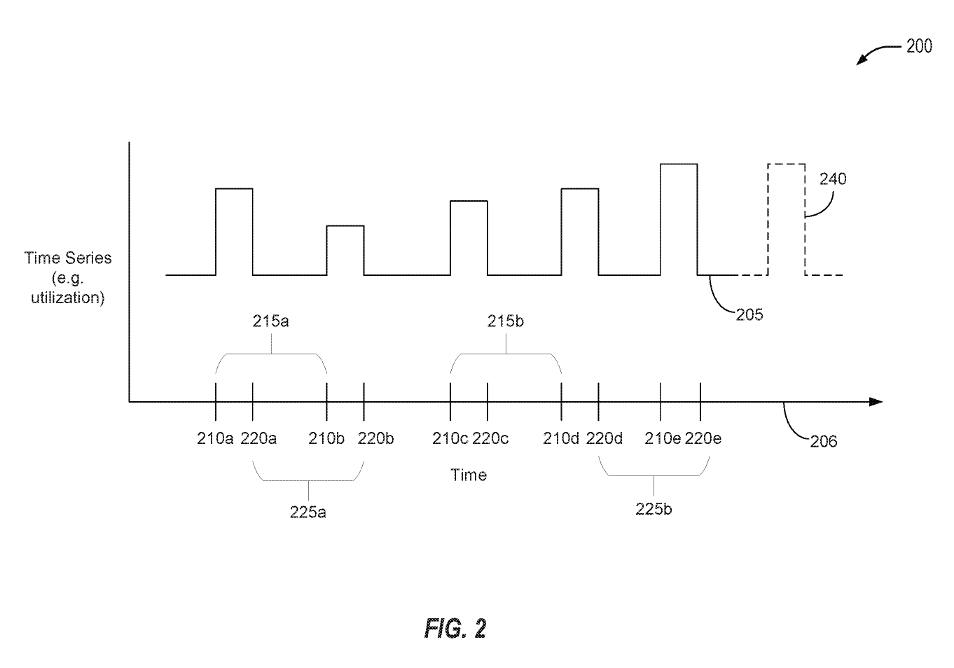

FIG. 2 shows a time series of data that may be analyzed to forecast an event in some aspects of the present disclosed. The example time series 205 exhibits some patterns with respect to time. In the example of FIG. 2, time itself may be considered a time series, and is illustrated as time series 206. For example, values of the time series 205 appear to increase at each of times 210a-e, which are approximately equally spaced apart, as demonstrated by elapsed time 215a between times 210a-b and elapsed time 215b between times 210c and 210d. Elapsed times 215a and 215b are of approximately equal duration. In some aspects, the time series 205 may represent utilization measurements of a network. The time series 205 also exhibits distinct reductions in value, shown at times 220a-e. The distinct reductions in value are also approximately equally spaced in time, as demonstrated by elapsed times 225a and 225b being approximately equal.

The pattern of increases in value at times 210a-e and decreases in value at times 220a-e of the time series may be used to predict future values of the time series by some embodiments of the present disclosure. For example, some embodiments of the present disclosure may forecast another increase and decrease in the time series 205 shown as forecast 240.

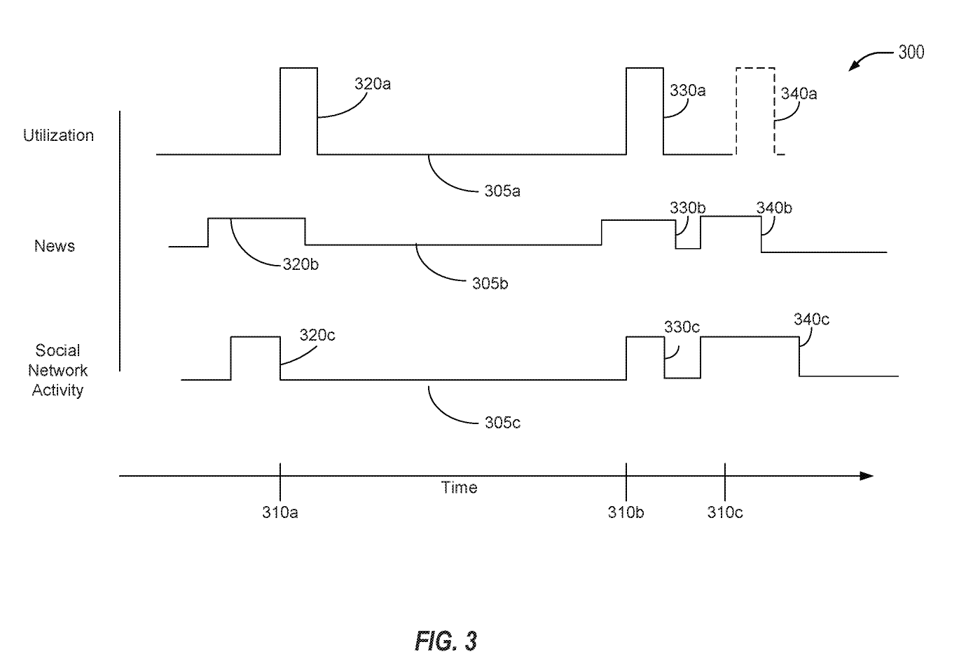

FIG. 3 shows multiple time series of data that may be analyzed to forecast an event in some aspects of the present disclosed. The diagram 300 shows a first time series 305a, representing utilization information for a first network, which may be any of the networks 105a-b of FIG. 1. The time series 305a may be retrieved in some aspects, from historical usage information data store 108d, discussed above with respect to FIG. 1. A second time series 305b representing news information, and a third time series 305c representing social media information, are also shown in FIG. 3. The second time series 305b may be retrieved, in some aspects, from the news data store 108b, discussed above with respect to FIG. 1. While the three time series 305a share the same y axis in FIG. 3, the values represented by the three time series 305a on the y axis may differ. For example, time series 305a shows utilization of a network, which may be represented for example, in bytes transmitted per unit of time, available buffer space, used capacity over total capacity, or any other unit of utilization. Time series 305b may represent a volume of news over time relevant to the utilization 305a. A variety of metrics could be used in various embodiments to represent the volume of news. For example, one embodiment could count a number of postings relevant to the utilization of the first network. Alternatively, another embodiment could combine a count of the number of postings with a measurement of the size of each posting, for example, a number of words in each posting. Thus, time series 305b could represent a total number of words in news postings relating to utilization of the first network. Time series 305c could similarly represent a count of a number of postings on a social network or a total number of words in postings on the social network that are relevant to a network being monitored (such as the first network). Some embodiments may include a filtering program that reads data available from the news data store 108b, and filters the information to identify information relevant to one or more networks being monitored by the forecasting engine 106.

While news information may include a wide variety of information, this discussion of FIG. 3 relates to news information that may be filtered to be relevant to a defined set of subjects or topics. For example, the time series 305b may represent news information relating to relatively large news events, such as relatively large weather events, political events, sporting events, or the like. These events may be selected as events predictive of an increase in network utilization. In some aspects, the time series 305b may be filtered and/or selected so as to represent a count of occurrences of news events that may affect utilization of the first network represented by the time series 305a. In some aspects, values of the time series 305b may combine a numericity and a length of news items referencing the first network.

The time series 305c may represent selected social media activity. In some aspects, the time series 305c may be retrieved from the social network information data store 108a, discussed above with respect to FIG. 1. In some aspects, the time series 305c may represent a number of social media postings meeting one or more criterion. For example, the social media postings counted as part of time series 305c may reference (e.g. via keywords or other references) the first network measured by the utilization time series 305a. In some examples, the social criterion may be predictive of network utilization. For example, social media posts in a particular location that would utilize one of the networks and may include one or more keywords that are predictive of network utilization. Keywords for news stories or social networking activity may be determined by an administrator or by one or more machine learning algorithms. For example, a corpus of keywords and/or phrases may be compared with network usage statistics to determine which keywords are predictive of network congestion. The social media posts and news feeds may be searched for these keywords or key phrases.

As shown in FIG. 3, the utilization of the first network as represented by the time series 305a shows two events 320a, and 330a, comprised of sharp increases in value and then later decreases in value, at approximately times 310a-b respectively. Preceding the increases in value of the events 320a and 330a of time series 305a, the time series of news information 305b relating to the first network also shows events 320b and 330b, comprised also of increases in value and decreases in value, shows at times 320a-b. Similarly, the social media activity relating to the first network represented by time series 305a also shows events 320c and 330c including both increases in value and decreases in value at times 330a-b. FIG. 3 shows that the time series 305b and/or time series 305c may be cross correlated with time series 305a and function as “leading indicators” for utilization of the first network represented by time series 305a. Embodiments of the present disclosure may utilize time series data, such as 305b-c to predict utilization of a network, or the time series 305a. For example, events 340b and/or 340c occurring in time series 305b-c respectively, may be used, based on cross correlations between the time series 305a and 305b, and also between the time series 305a and 305c, to predict an event in the time series 305a, shown as event 340a in FIG. 3.

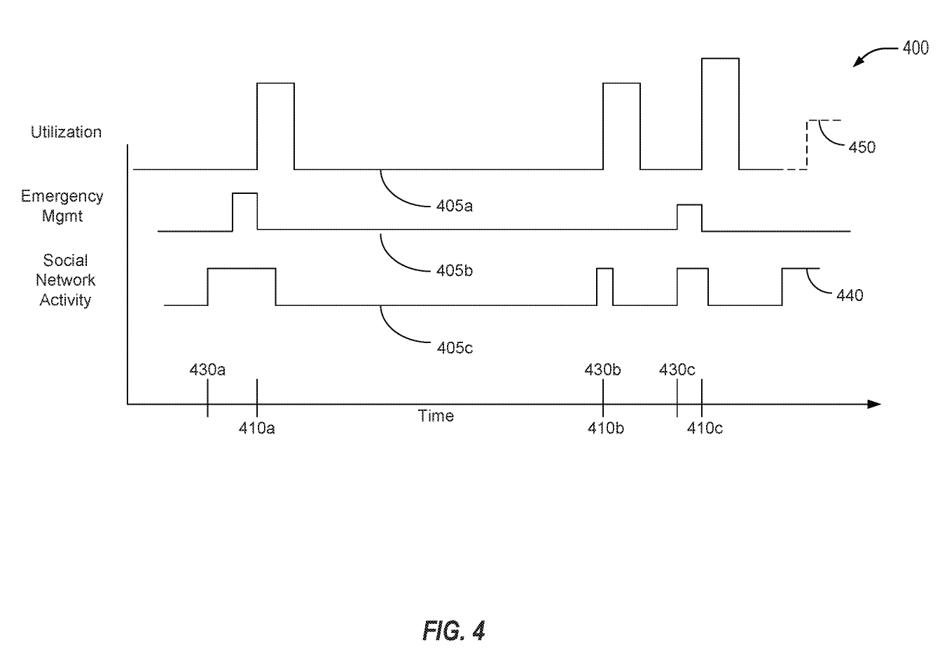

FIG. 4 shows multiple time series of data that may be analyzed to forecast an event in some aspects of the present disclosure. FIG. 4 shows a time series 405a representing utilization measurements of a first network, such as any one of the networks 105a-b of FIG. 1. FIG. 4 also shows a time series 405 representing emergency management information. In some aspects, the time series 405b may be retrieved from the emergency management data store 108c discussed above with respect to FIG. 1. In some aspects, data in the emergency management data store 108c may be filtered or otherwise processed to generate the time series 405b. For example, emergency management information relating to the network represented by utilization time series 405a may be filtered from the emergency management information in the data store 108d to create the time series 405a. FIG. 4 also shows a social network activity time series 405c. In some aspects, the time series 405c may be obtained from the social network information data store 108a, discussed above with respect to FIG. 1. In some aspects, data in the social network information data store 108a may be filtered or otherwise screened to obtain data relevant to the network represented by utilization measurements of the time series 405a. In some aspects, the time series 405c may represent a count of social media postings relating to the first network 405a.

Utilization time series 405a shows increases in value at times 410a-c. For two of the changes in value, specifically at times 410a and 410c, the emergency management time series 405b also indicates activity before the increases, specifically at times 420a and 420b. The third time series 405c also shows increases in activity preceding each of the increases in utilization represented by time series 405a. These increases in activity are shown at times 430a-c. The changes in values of the time series 405b-c may function as leading indicators for the time series 405a. Thus, aspects of the present disclosure may forecast events relating to the time series 405a based on the time series 405b-c. Aspects of the present disclosure may identify cross correlations between multiple time series (e.g. 405a-c). In some aspects, events in one time series (e.g. events occurring in time series 405c at times 430a and 430b) may predict events in another time series (e.g. events in time series 405a at times 410a and 410b). This cross-correlation between time series may be used to forecast events in a time series, such as the time series 405a. FIG. 4 shows an event 440 occurring in the time series 405b being used to forecast an event 450 in the time series 405a, based on a cross correlation between the time series 405a and the time series 405b.

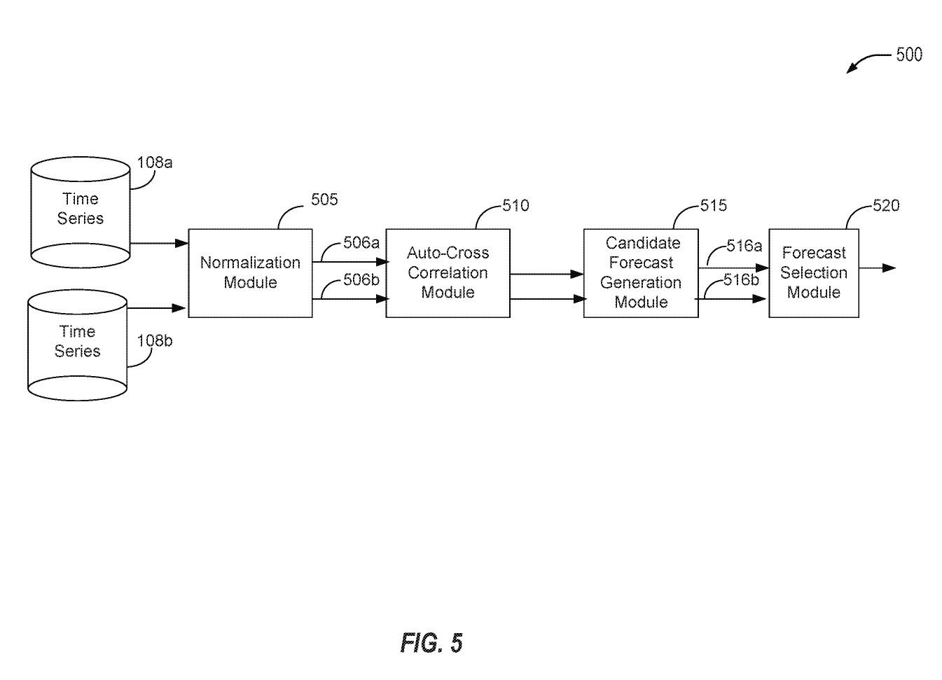

FIG. 5 is a data flow diagram showing how forecasting of events based on time series data may be provided in some of the disclosed embodiments. A normalization module 505 receives two or more time series data from one or more data stores. As shown in FIG. 5, the normalization module 505 receives time series data from data stores 108a and 108b, discussed above with respect to FIG. 1. While data stores 108a and 108b are shown, the time series may be received from any of the data stores 108a-d discussed above with respect to FIG. 1. In some aspects, the normalization module 505 may remove linearity from the time series data, such that a mean of the time series data tends to zero. In some aspects, the normalization module 505 may determine a standard deviations for each of the time series data 108a-b. In some aspects, each time series may be divided by its respective standard deviation.

After the normalization module 505 completes the normalization process, the resulting data 506a-b is provided to an auto-cross correlation module 510. In some aspects, one or more auto correlation functions may be determined based on the normalized data 506. The auto cross correlation module 510 calculates at least one cross-correlation function for the normalized data 506a-b. A variety of techniques may be used to determine the auto cross correlation function(s) in the auto correlation module 510. For example, in some aspects, the Wiener-Khinchin theorem may be used to compute an autocorrelation from the normalized data 506a and or 506b.

The auto cross correlation functions determined by the auto cross correlation module 510 may then be provided to a candidate forecast generation module 515, which generates possible forecasts for events based on the auto cross correlation functions of the time series. The candidate forecast generation module 515 may also provide a confidence interval or prediction interval associated with each of the candidate forecasts. The confidence interval and/or prediction interval and candidate forecasts 516 may then be provide to a forecast selection module 520. The forecast selection module 520 may then determine whether any of the candidate forecasts provided by the candidate forecast generation module 515 are selected to forecast an event. In some aspects, candidates may be selected based on the confidence interval or prediction interval associated with the candidate forecast. For example, if the confidence value is above a threshold or otherwise meets one or more criterion, then the candidate forecast may be selected to forecast an event. Alternatively, confidence intervals and/or prediction intervals for several candidate forecasts provided by the candidate forecast generation module 515, with one or more of the candidate forecasts with the highest confidence and/or prediction intervals selected to predict an event.

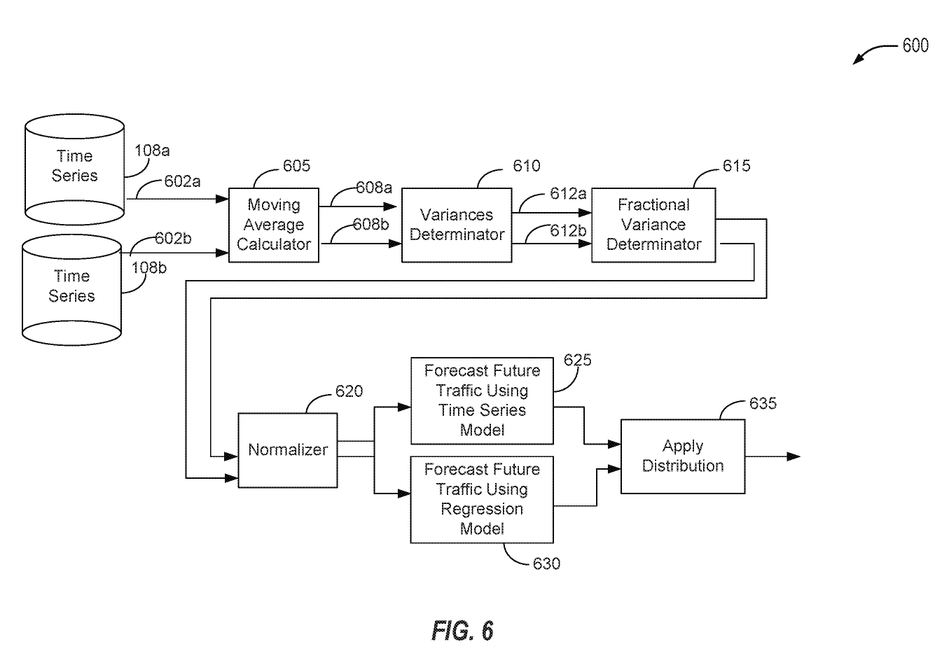

FIG. 6 shows a data flow that may be implemented in at least some of the disclosed embodiments. The data flow 600 of FIG. 6 shows time series data 602a-b from the data stores 108a-b being provided to a moving average calculator 605. The moving average calculator 605 may periodically generate a moving average for the time series data In some aspects, the moving average determined by the moving average calculator may be a centered moving average. Moving average data 608a-b then passes to a variance determinator 610. The variance determinator 610 may determine variances for moving averages in the time series data 608a-b. For example, in some aspects, the variance determinator 610 will divide a value in the time series corresponding to a particular time within the series with a moving average corresponding to that same time. The variance determinator thus generates variance data 612a-b. A fractional variance determinator 615 may then determine a ratio of individual variances included in the variance data 612a-b to a total variance of a period of time. For example, the fractional variance determinator 615 may add up variances occurring within a time period, such as a time period of one hour, one day, or one week, or any particular time period. For each individual variance within the time period, a determination will be made of the fractional percentage of that variance to the total variance. The fractional variances are then provided to a normalizer 620. The normalizer 620 then normalizes each fractional variance according to a summation of the fractional variances. The normalized fractional variances may then be applied to one or more of a time series model 625 and/or regression model 630. By providing a portion of the time series data, forecasted events for future time may be generated. In some aspects, an autoregressive integrated moving average time-series model may be used (ARIMA). In some aspects, an ARIMA model may be used. A regression model 630 may also be applied to the normalized data. Block 635 then applies predictions generated by the time series model and/or regression model to forecast an event.

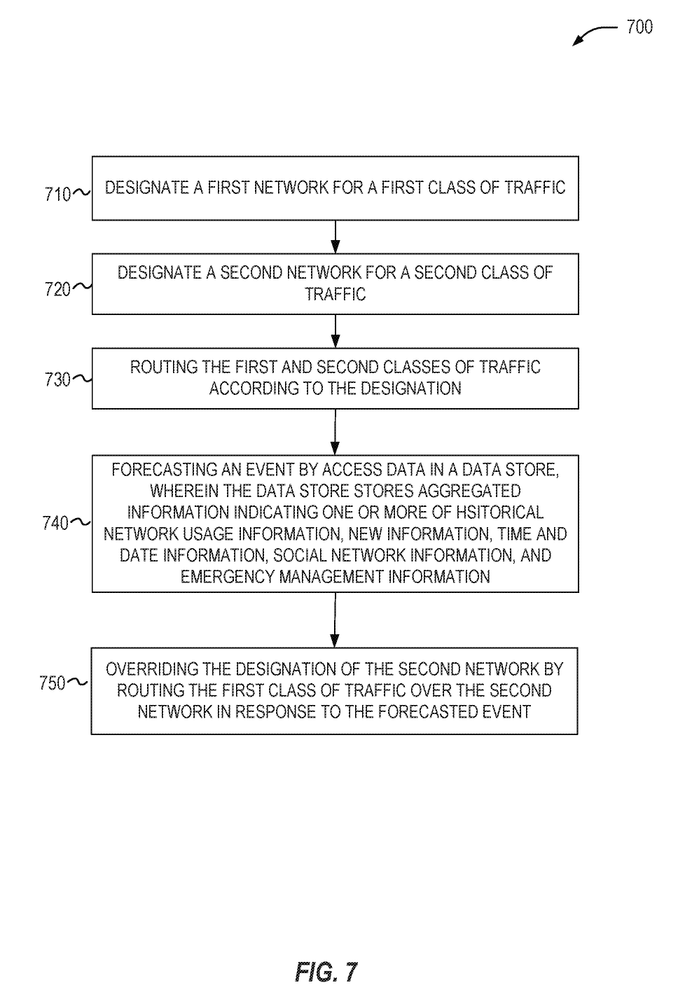

FIG. 7 is a flowchart of a method for forecasting an event and overriding a designation of a first network based on the forecast event. In some aspects, the method 700 discussed below with respect to FIG. 7 may be performed by the intelligent engine 102, discussed above with respect to FIG. 1. For example, a memory may store instructions that configure processing circuitry included as part of the intelligent engine 102 to perform one or more of the functions discussed below with respect to FIG. 7.

Process 700 provides for a designation of a first network for a first class of traffic to be overridden, such that the first network is used for a second class of traffic. The overriding of the designation may be in response to a forecast event. As discussed above, embodiments of this disclosure may forecast changes in network utilization based on activity external to the network itself. For example, some embodiments may examine one or more of news information, social media information, calendar information including date/time information, and information available from governmental agencies, such as emergency management information to forecast an event on a network. The designations of particular networks for particular classes of traffic may be made for business reasons in some aspects. For example, some networks may be relatively expensive to operate, but may provide benefits over other networks, such as relatively high reliability, low latency, high capacity, or other desirable characteristics. Other networks may be less expensive to operate, but perhaps have some disadvantages relative to the more expensive networks.

In block 710, traffic of a first type or from a first type of customer, such as a consumer, may be designated to use a first network. In some aspects, consumer traffic may be traffic received from a source IP address within a defined range of IP addresses. In some aspects, network providers may allocate a first range or ranges of IP addresses for use by consumer accounts and a second range or ranges of IP addresses for use by enterprise accounts.

In some aspects, the first network may be the network 105a, discussed above with respect to FIG. 1. In some aspects, designating a first type of traffic for the first network may include setting a routing policy within the intelligent engine 102 to direct traffic from the first type of customer or traffic of the first type over the first network. For example, the intelligent engine 102 may direct traffic to the first network 105a by communication control information to the multiplexer (e.g. 110) to route the traffic to the first network 105a (e.g. via control signals 108b).

In block 720, a second type of traffic, such as enterprise traffic may be designated to use a second different network. In some aspects, enterprise traffic may be traffic received from a second set of source IP addresses. For example, a network provider may allocate certain IP address ranges for consumer traffic and certain other IP address ranges for enterprise traffic. Other methods of distinguishing consumer traffic from enterprise traffic are also contemplated.

The second network may be the network 105a, discussed above with respect to FIG. 1. In some aspects, designating a second type of traffic for the second network may include setting a routing policy within the intelligent engine 102 to direct traffic from the second type of customer or traffic of the second type over the second network.

In block 730, traffic of the first and second classes is routed according to the designation. For example, the intelligent engine 102 may receive traffic from a first type of customer (e.g. 103a), and route the traffic (e.g. via mux 110) according to a designation (e.g. policy referenced by the policy engine 104) to the first network 105a. The intelligent engine 102 may also receive second traffic from a second type of customer (e.g. 103b) and route this second traffic (e.g. via max 110) according to its designation. The second traffic may be designated for a second network (e.g. 105b).

In block 740, an event may be forecast based on data in a data store. As described above with respect to FIG. 1, the data store may include one or more physical data stores. The data store may include information in one or more of the data stores 108a-d discussed above with respect to FIG. 1. The data store may include one or more of historical network usage information (e.g. 108d), news information (e.g. 108b), time and date information, social network information (e.g. 108a), and emergency management information (e.g. 108c). In some aspects, the data store may also indicate weather information and/or electric power availability information. Each of the data stores may include information organized as a time series. For example, the historical usage information in the data store 108d may provide usage information for the first and/or second networks over a period of time.

Information in the data store may be analyzed to determined patterns or cross correlations that may be used to predict or forecast future events. The forecast events may indicate forecast utilization levels for the first and/or second network in some aspects. In some aspects, the determined pattern(s) may also indicate time periods associated with the forecast events and/or utilizations. For example, one or more patterns identified in the data store may indicate a level of utilization of the first or second network will be maintained for a threshold period of time. In some aspects, the forecast level of utilization may be forecast for a future period of time of one minute, five minutes, ten minutes, fifteen minutes, one hour, two hours, or a time period of any length.

In some aspects, patterns may be detected in data obtained from the data store that are correlated with certain dates. For example, lower usage patterns may be detected on and/or near certain regional and recurring holidays, such as memorial day, labor day, independent day, or other regional holidays. If one or more dates of these recurring holidays are within a threshold period of time of a current date, an event may be forecast based on the correlation of the lower usage patterns with the recurring dates and the current dates. For example, if a date of a recurring holiday is within one day of a current date, a reduced utilization event may be forecast for the second network. A length or duration of the forecast event may be set based on previous utilization experienced during past occurrences of the recurring holiday and surrounding time frames.

In some aspects, cross correlations may be established between particular types of activity on a social network and events on the second network. For example, in some aspects, block 740 may filter activity on a social network to identify social network postings including a name of the second network. For example, if the second network is named “Arpanet,” social network posts referencing “Arpanet” may be identified. If a count of the number of social network posts reference “Arpanet” meets one or more criterion, an event relating to usage of the “Arpanet” may be forecast. In some aspects, the social network postings may be further analyzed to determine a nature of the social media posts. For example, postings relating to negative information regarding Arpanet may indicate reduced usage, while posting including positive information may indicate an increase in utilization. In some aspects, one or more functions of the data flows 500 and/or 600 described above with respect to FIGS. 5 and/or 6 may be included in block 740. For example, in some aspects, identification of the patterns discussed above may be based on moving average determinations of one or more time series, as discussed above. In some aspects, auto cross correlation functions of one or more time series may be identified, with the auto cross correlation functions used to predict patterns and forecast future events.

In some aspects, cross correlations may be determined between first activity on one or more social networks and utilization of the second network based on the aggregated information. Process 700 may also detect second activity on the social network; determining a similarity score between the first activity and the second activity, and forecasting the event based on the similarity score and the cross correlation between the first activity and the utilization of the second network.

In some aspects, a time series indicating when maintenance activity is performed on the second network may be analyzed. Patterns in the maintenance activity may be cross correlated with particular dates based on the aggregated information. If the cross correlation between the past maintenance activity and a future date indicates an upcoming maintenance window, an event may be forecast based on the cross-correlation. Based on the forecast maintenance event, the designation of the second network for network data of the second class may be maintained. Alternatively, another network may be designated for traffic of the second class to compensate for the reduced capacity of the second network during the maintenance activity.

In block 750, the designation of the second network for traffic of the second type is overridden, such that network traffic of the first type is routed over the second network based on the forecast event. In some aspects, block 750 may include evaluating the forecast event and the time period for the event to determine whether to override the designation. For example, in some aspects, if the time period for the event is longer than a threshold period of time, the designation may be overridden.

In some aspects, overriding the designation may include receiving traffic of the first class, and transmitting the traffic of the first class to a multiplexer (e.g. 110), along with an indication that the traffic of the first class is to be transmitted over the second network.

In some aspects, process 700 may be iteratively performed, and the time period for the event reduced as time elapses. Thus, subsequent iterations may continue to compare a remaining time period for the event when determining whether the designation may be overridden for further traffic. As the time period remaining for the event is reduced with the passage of time, the remaining time of the event may cross below a minimum time threshold for overriding the designation. In some aspects, when this occurs, the routing of traffic may again conform to the designations.

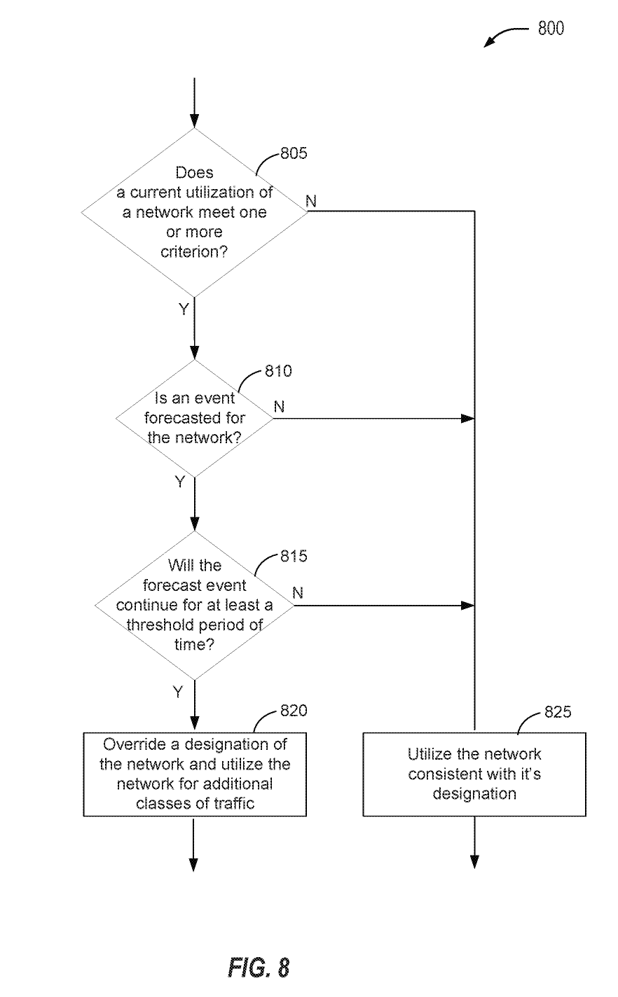

FIG. 8 is a flowchart of a method for determining whether to override a designation of a network. As discussed above, in some aspects, a network may be designated to service a first class of traffic. Depending on the forecast utilization of the network, the designation may be overridden such that the network may also service other classes of traffic. In some aspects, one or more of the functions discussed below may be performed by the intelligent engine 102 and/or the policy engine 104, and/or forecasting engine 106.

Decision block 805 determines whether a current utilization of a network meets one or more criterion. For example, block 805 may determine whether the utilization of the network is below a threshold percentage. If the utilization does not meet the criterion, processing passes to block 825, discussed below. If the utilization does meet the criterion, process 800 moves from decision block 805 to decision block 810, which determines if an event is forecasted for the network. As discussed above, in some aspects, one or more time series may be analyzed to determine auto correlation functions for the time series. In some aspects, a regression model may be applied to the time series. One or more of the auto correlation functions and/or the regression model may be used to determine if an event is forecast for the network. Furthermore, decision block 810 may also determine a length of time or duration of the event. If an event is not forecast for the network within a threshold period of time, processing moves from block 810 to block 825, discussed below. If an event is forecast, processing moves from decision block 810 to block 815, which determines whether a duration of length of the forecast event is at least a threshold period of time. In some aspects, decision block 815 may also evaluate whether the event will result in a utilization of the network dropping below a defined utilization threshold.

If the duration of the event is below the threshold period of time (and in some aspects, if the predicted utilization is below the defined utilization threshold), process 800 moves from block 815 to block 825, discussed below. Otherwise, if the duration of the event is greater than the threshold period of time, process 800 moves from decision block 815 to block 820, which overrides the designation of the network and utilizes the network for additional classes of traffic. For example, while the network may have been designated for a first class of traffic upon beginning process 800 at block 805, block 820 may designate additional classes of traffic for the network. For example, the network may be designated to service a second, third, and/or fourth class of traffic, in addition to the first class of traffic. Designating the network to service one or more classes of traffic may include modifying a policy structure in the policy engine 104 that will cause the intelligent engine to route traffic of the one or more classes of traffic over the first network. If any of the conditions specified in decision blocks 805, 810, or 815 are not satisfied, processing moves to block 825, which utilizes the network consistent with the designation. Thus, for example, if block 820 designates the network to service a second, third and/or fourth class of traffic, in block 825, these classes of traffic remain designated for other networks, and not for the network discussed with respect to process 800.

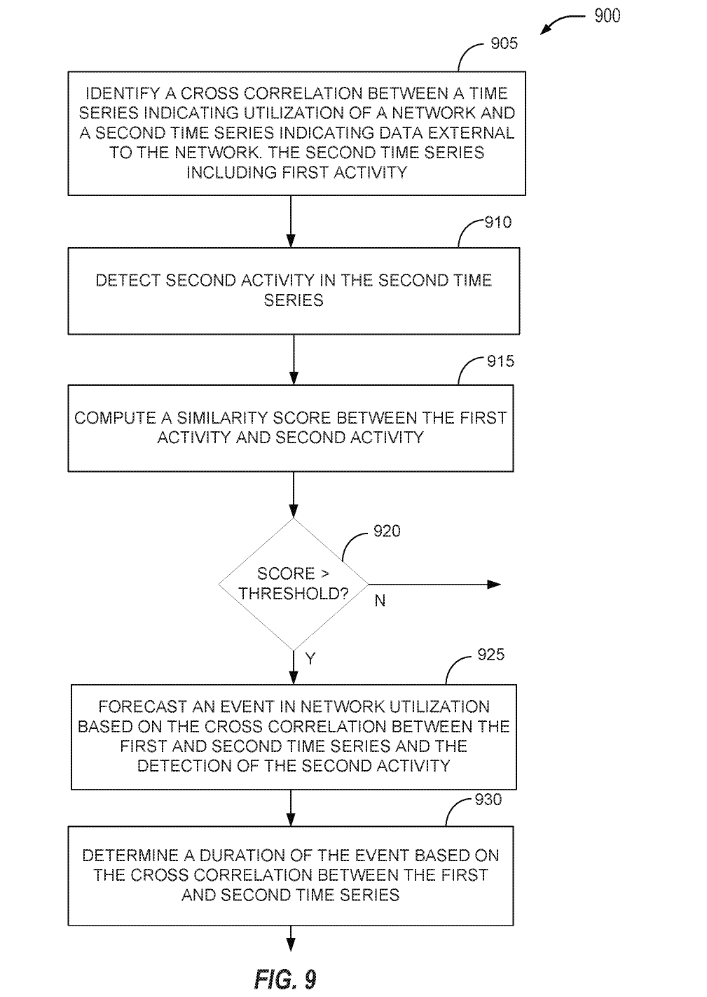

FIG. 9 is a flowchart of an example method for forecasting an event. As discussed above, at least some of the disclosed embodiments may forecast an event on a network based on a cross correlation between prior utilization of the network and activity occurring in other environments. When certain activity is detected in these environments, it may serve as a leading indicator for an event on the network. In some aspects, process 900 discussed below with respect to FIG. 9 may be performed by the forecasting engine 106, discussed above with respect to FIG. 1. In some aspects, process 900 may be performed as part of block 740, discussed above with respect to FIG. 7.

In block 905, a cross correlation is identified between a first time series indicating utilization of a network and a second time series. The second time series may indicate data external to the network. For example, as discussed above with respect to FIG. 1, the second time series could indicate social network activity over time, emergency management information over time, or news information over time. Electronic power availability information over time and/or weather information over time may also be considered by process 900. The second time series may include first activity. For example, as discussed above with respect to FIGS. 2-4, a second time series may exhibit certain characteristics or activities that are correlated with activity of a first time series, such as utilization. In the example of FIG. 2, the utilization 205 exhibits a periodic nature, and is thus correlated with the passage of time. In the example of FIG. 3, activity in the utilization 305a is cross-correlated with certain events occurring in time series 305b and/or 305c. In the example of FIG. 4, changes in utilization 405a are cross correlated with changes in activity of the time series 405b and/or 405c. In block 905, the second time series includes a first activity or characteristic. For example, as demonstrated in the example of FIG. 3, the time series 305b exhibits a characteristic or activity 320b. The activity 320b precedes (in time), a change 320a in utilization time series 305a. The cross-correlation determined in block 905 may associate the characteristic 320b with the change 320 in utilization.

In block 910, activity is detected in the second time series. The activity in the second time series may represent a second pattern or characteristic of the second time series. For example, as illustrated in FIG. 3, activity such as 340b or 340c may be detected.

In block 915, a similarity score is computed between the first activity and the second activity. For example, block 915 may compare one or more of the height, shape, and timing of the activity 320b and 340b, and or 330c and 340c, to determine if the second activity is sufficiently similar to the first activity. In other words, if the first activity (e.g. 320b) preceded a change in utilization (e.g. 320a), then a sufficiently similar second activity (e.g. 340c) may precede a similar change in utilization (e.g. 340a).

Decision block 920 determines if the similarity score meets a criterion or in other words, block 920 determines if the first and second activities are sufficiently similar. If it is not sufficiently similar, no events may be forecast based on the second activity. If the two activities are sufficiently similar, process 900 moves to block 925, which forecasts an event in network utilization based on the cross correlation between the two times series and the occurrence of the second activity.

In block 930, a duration of the event is determined based on the cross correlation between the first and second time series. In some aspects, the duration may also be based on the second activity. For example, one or more characteristics of the second activity may indicate the duration. For example, in some aspects, a magnitude of a change in value of the second time series during the second activity may be proportional to a duration of the event.

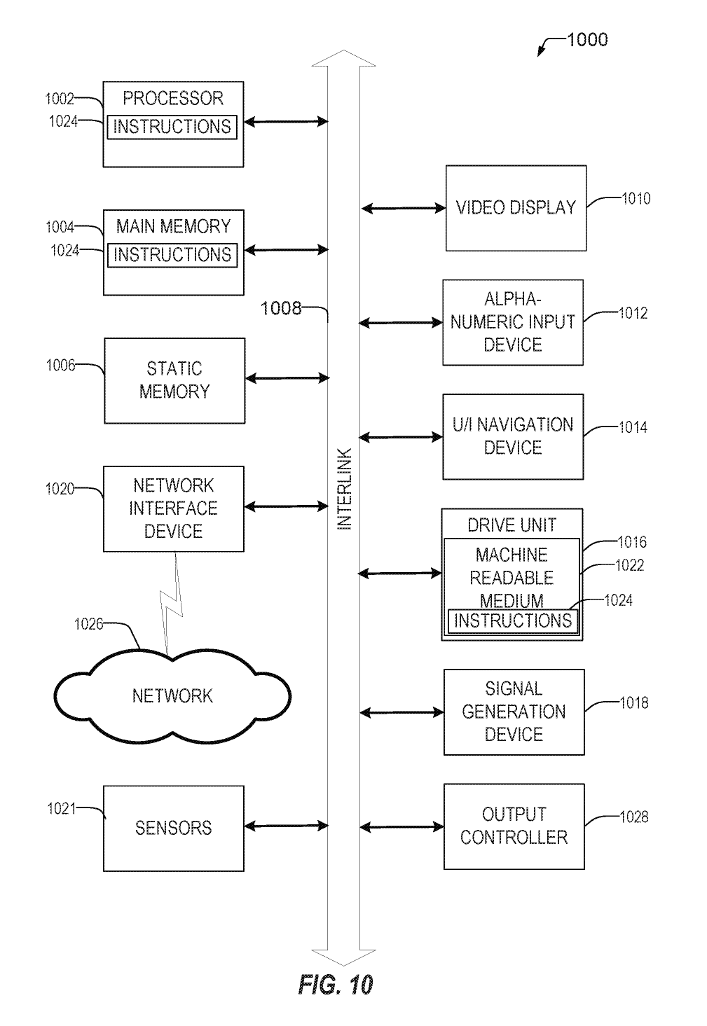

FIG. 10 illustrates a block diagram of an example machine 1000 upon which any one or more of the techniques (e.g., methodologies) discussed herein may perform. In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may be a personal computer (PC), a tablet PC, a set-top box (STB), a personal digital assistant (PDA), a mobile telephone, a smart phone, a web appliance, a network router, switch or bridge, a server computer, a database, conference room equipment, or any machine capable of executing instructions (sequential or otherwise) that specify actions to be taken by that machine. Machine 1000 may implement, in whole or in part, the any one of the intelligent engine 102, policy engine 104 and/or forecasting engine 106. In various embodiments, machine 1000 may perform one or more of the processes described above with respect to FIGS. 7 and/or 8 and/or 9. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms (all referred to hereinafter as “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The machine 1000 may further include a display unit 1010, an alphanumeric input device 1012 (e.g., a keyboard), and a user interface (UI) navigation device 1014 (e.g., a mouse). In an example, the display unit 1010, input device 1012 and UI navigation device 1014 may be a touch screen display. The machine 1000 may additionally include a storage device (e.g., drive unit) 1016, a signal generation device 1018 (e.g., a speaker), a network interface device 1020, and one or more sensors 1021, such as a global positioning system (GPS) sensor, compass, accelerometer, or other sensor. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1016 may include a machine readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within static memory 1006, or within the hardware processor 1002 during execution thereof by the machine 1000. In an example, one or any combination of the hardware processor 1002, the main memory 1004, the static memory 1006, or the storage device 1016 may constitute machine readable media.

While the machine readable medium 1022 is illustrated as a single medium, the term “machine readable medium” may include a single medium or multiple media (e.g., a centralized or distributed database, and/or associated caches and servers) configured to store the one or more instructions 1024.

The term “machine readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 1024 may further be transmitted or received over a communications network 1026 using a transmission medium via the network interface device 1020. The machine 1000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 1020 may include one or more physical jacks (e.g., Ethernet, coaxial, or phone jacks) or one or more antennas to connect to the communications network 1026. In an example, the network interface device 1020 may include a plurality of antennas to wirelessly communicate using at least one of single-input multiple-output (SIMO), multiple-input multiple-output (MIMO), or multiple-input single-output (MISO) techniques. In some examples, the network interface device 1020 may wirelessly communicate using Multiple User MIMO techniques.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Example 1 is a system comprising processing circuitry; an electronic hardware memory storing instructions that, when executed by the processing circuitry, control the system to perform operations comprising: designating a first network for a first class of traffic; designating a second network for a second class of traffic; routing the first and second classes of traffic according to the designation; forecasting an event by accessing data in a data store, wherein the data store stores aggregated information indicating one or more of historical network usage information, news information, time and date information, social network information, and emergency management information; and overriding the designation of the second network by routing the first class of traffic over the second network in response to the forecasted event.

In Example 2, the subject matter of Example 1 optionally includes the operations further comprising analyzing information in the data store to determine a cross correlation between a first time series indicating utilization of the second network and a second time series indicating the one or more of news information, time and date information, and social network information, and wherein the operations of forecasting the event comprises forecasting the event based on the cross correlation.

In Example 3, the subject matter of Example 2 optionally includes the operations further comprising detecting a cross correlation between utilization of the second network and a time series included in the aggregated information indicating particular dates; correlating the particular dates with future dates within a predetermined date window of a current date, and wherein the operations of forecasting the event comprises forecasting the event based on the correlating.

In Example 4, the subject matter of any one or more of Examples 2-3 optionally include the operations further comprising detecting a cross correlation between first activity on a social network and utilization of the second network based on the aggregated information; detecting second activity on the social network; determining a similarity score between the first activity and the second activity, and forecasting the event based on the similarity score and the cross correlation between the first activity and the utilization of the second network.

In Example 5, the subject matter of any one or more of Examples 2-4 optionally include the operations further comprising detecting a pattern in maintenance activity of the second network on particular dates based on the aggregated information; correlating the particular dates with other dates, the other dates with a predetermined data window of a current date, and forecasting the event based on the correlating.

In Example 6, the subject matter of any one or more of Examples 1-5 optionally include the operations further comprising receiving weather information from a weather service, and forecasting the event based on the weather information.

In Example 7, the subject matter of any one or more of Examples 1-6 optionally include the operations further comprising aggregating electric power service availability information, and forecasting the event based on the electric power service availability information.

In Example 8, the subject matter of any one or more of Examples 1-7 optionally include wherein the first class of traffic is consumer traffic and the second class of traffic is enterprise traffic.

In Example 9, the subject matter of Example 8 optionally includes wherein the first network is an Internet Protocol network, a Time Division Multiplexing network, or a wireless network and the second network in an Internet Protocol network, a Time Division Multiplexing network, or a wireless network.

In Example 10, the subject matter of any one or more of Examples 1-9 optionally include the operations further comprising predicting a utilization of the second network based on the forecasted event, and overriding the designation of the second network in response to the predicted utilization meeting a criterion.

In Example 11, the subject matter of Example 10 optionally includes wherein the criterion is met when the predicted utilization is below a utilization threshold.

In Example 12, the subject matter of any one or more of Examples 10-11 optionally include the operations further comprising aggregating periodic utilization measurements of the second network, wherein the forecasting is based on the measurements.

In Example 13, the subject matter of any one or more of Examples 1-12 optionally include the operations further comprising sending data of the first class with an indication of the second network to a multiplexer in response to the overriding of the designation, the indication configured to cause the multiplexer to send the data of the first class over the second network.

Example 14 is a method comprising designating a first network for a first class of traffic; designating a second network for a second class of traffic; routing the first and second classes of traffic according to the designation; forecasting an event by accessing data in a data store, wherein the data store stores aggregated information indicating one or more of historical network usage information, news information, time and date information, social network information, and emergency management information; and overriding the designation of the second network by routing the first class of traffic over the second network in response to the forecasted event.

In Example 15, the subject matter of Example 14 optionally includes analyzing information in the data store to determine a cross correlation between a first time series indicating utilization of the second network and a second time series indicating the one or more of news information, time and date information, and social network information, and wherein the forecasting of the event comprises forecasting the event based on the cross correlation.

In Example 16, the subject matter of Example 15 optionally includes detecting a cross correlation between utilization of the second network and a time series included in the aggregated information indicating particular dates; correlating the particular dates with future dates within a predetermined date window of a current date, and wherein forecasting the event comprises forecasting the event based on the correlating.

In Example 17, the subject matter of any one or more of Examples 15-16 optionally include detecting a cross correlation between first activity on a social network and utilization of the second network based on the aggregated information; detecting second activity on the social network; determining a similarity score between the first activity and the second activity, and wherein forecasting the event comprises forecasting the event based on the similarity score and the cross correlation between the first activity and the utilization of the second network.

In Example 18, the subject matter of any one or more of Examples 15-17 optionally include detecting a pattern in maintenance activity of the second network on particular dates based on the aggregated information; correlating the particular dates with other dates, the other dates with a predetermined data window of a current date, and forecasting the event based on the correlating.

In Example 19, the subject matter of any one or more of Examples 14-18 optionally include receiving weather information from a weather service, and forecasting the event based on the weather information.

In Example 20, the subject matter of any one or more of Examples 14-19 optionally include aggregating electric power service availability information, and forecasting the event based on the electric power service availability information.

In Example 21, the subject matter of any one or more of Examples 14-20 optionally include wherein the first class of traffic is consumer traffic and the second class of traffic is enterprise traffic.

In Example 22, the subject matter of Example 21 optionally includes wherein the first network is an Internet Protocol network, a Time Division Multiplexing network, or a wireless network and the second network in an Internet Protocol network, a Time Division Multiplexing network, or a wireless network.

In Example 23, the subject matter of any one or more of Examples 14-22 optionally include predicting a utilization of the second network based on the forecasted event, and overriding the designation of the second network in response to the predicted utilization meeting a criterion.

In Example 24, the subject matter of Example 23 optionally includes wherein the criterion is met when the predicted utilization is below a utilization threshold.

In Example 25, the subject matter of any one or more of Examples 23-24 optionally include aggregating periodic utilization measurements of the second network, wherein the forecasting is based on the measurements.

In Example 26, the subject matter of any one or more of Examples 14-25 optionally include sending data of the first class with an indication of the second network to a multiplexer in response to the overriding of the designation, the indication configured to cause the multiplexer to send the data of the first class over the second network.

Example 27 is an apparatus comprising means for designating a first network for a first class of traffic; means for designating a second network for a second class of traffic; means for routing the first and second classes of traffic according to the designation; means for forecasting an event by accessing data in a data store, wherein the data store stores aggregated information indicating one or more of historical network usage information, news information, time and date information, social network information, and emergency management information; and means for overriding the designation of the second network by routing the first class of traffic over the second network in response to the forecasted event.

In Example 28, the subject matter of Example 27 optionally includes means for analyzing information in the data store to determine a cross correlation between a first time series indicating utilization of the second network and a second time series indicating the one or more of news information, time and date information, and social network information, and wherein the means for forecasting the event is configured to forecast the event based on the cross correlation.

In Example 29, the subject matter of Example 28 optionally includes means for detecting a cross correlation between utilization of the second network and a time series included in the aggregated information indicating particular dates; correlating the particular dates with future dates within a predetermined date window of a current date, and wherein the means for forecasting the event is configured to forecast the event based on the correlating.

In Example 30, the subject matter of any one or more of Examples 28-29 optionally include means for detecting a cross correlation between first activity on a social network and utilization of the second network based on the aggregated information; detecting second activity on the social network; determining a similarity score between the first activity and the second activity, and forecasting the event based on the similarity score and the cross correlation between the first activity and the utilization of the second network.

In Example 31, the subject matter of any one or more of Examples 28-30 optionally include means for detecting a pattern in maintenance activity of the second network on particular dates based on the aggregated information; correlating the particular dates with other dates, the other dates with a predetermined data window of a current date, and forecasting the event based on the correlating.

In Example 32, the subject matter of any one or more of Examples 27-31 optionally include means for receiving weather information from a weather service, and forecasting the event based on the weather information.

In Example 33, the subject matter of any one or more of Examples 27-32 optionally include means for aggregating electric power service availability information, and forecasting the event based on the electric power service availability information.

In Example 34, the subject matter of any one or more of Examples 27-33 optionally include wherein the first class of traffic is consumer traffic and the second class of traffic is enterprise traffic.

In Example 35, the subject matter of any one or more of Examples 27-34 optionally include wherein the first network is an Internet Protocol network, a Time Division Multiplexing network, or a wireless network and the second network in an Internet Protocol network, a Time Division Multiplexing network, or a wireless network.

In Example 36, the subject matter of any one or more of Examples 27-35 optionally include means for predicting a utilization of the second network based on the forecasted event, and wherein the means for overriding the designation of the second network is configured to override the designation in response to the predicted utilization meeting a criterion.

In Example 37, the subject matter of Example 36 optionally includes wherein the criterion is met when the predicted utilization is below a utilization threshold.

In Example 38, the subject matter of any one or more of Examples 36-37 optionally include means for aggregating periodic utilization measurements of the second network, wherein the forecasting is based on the measurements.

In Example 39, the subject matter of any one or more of Examples 27-38 optionally include means for sending data of the first class with an indication of the second network to a multiplexer in response to the overriding of the designation, the indication configured to cause the multiplexer to send the data of the first class over the second network.

Example 40 is a non-transitory computer readable medium comprising instructions that when executed cause processing circuitry to perform operations comprising designating a first network for a first class of traffic; designating a second network for a second class of traffic; routing the first and second classes of traffic according to the designation; forecasting an event by accessing data in a data store, wherein the data store stores aggregated information indicating one or more of historical network usage information, news information, time and date information, social network information, and emergency management information; and overriding the designation of the second network by routing the first class of traffic over the second network in response to the forecasted event.

In Example 41, the subject matter of Example 40 optionally includes the operations further comprising analyzing information in the data store to determine a cross correlation between a first time series indicating utilization of the second network and a second time series indicating the one or more of news information, time and date information, and social network information, and wherein the forecasting of the event comprises forecasting the event based on the cross correlation.

In Example 42, the subject matter of Example 41 optionally includes the operations further comprising detecting a cross correlation between utilization of the second network and a time series included in the aggregated information indicating particular dates; correlating the particular dates with future dates within a predetermined date window of a current date, and wherein forecasting the event comprises forecasting the event based on the correlating.

In Example 43, the subject matter of any one or more of Examples 41-42 optionally include the operations further comprising detecting a cross correlation between first activity on a social network and utilization of the second network based on the aggregated information; detecting second activity on the social network; determining a similarity score between the first activity and the second activity, and wherein forecasting the event comprises forecasting the event based on the similarity score and the cross correlation between the first activity and the utilization of the second network.

In Example 44, the subject matter of any one or more of Examples 41-43 optionally include the operations further comprising detecting a pattern in maintenance activity of the second network on particular dates based on the aggregated information; correlating the particular dates with other dates, the other dates with a predetermined data window of a current date, and forecasting the event based on the correlating.

In Example 45, the subject matter of any one or more of Examples 40-44 optionally include the operations further comprising receiving weather information from a weather service, and forecasting the event based on the weather information.

In Example 46, the subject matter of any one or more of Examples 40-45 optionally include the operations further comprising aggregating electric power service availability information, and forecasting the event based on the electric power service availability information.

In Example 47, the subject matter of any one or more of Examples 40-46 optionally include wherein the first class of traffic is consumer traffic and the second class of traffic is enterprise traffic.

In Example 48, the subject matter of any one or more of Examples 40-47 optionally include wherein the first network is an Internet Protocol network, a Time Division Multiplexing network, or a wireless network and the second network in an Internet Protocol network, a Time Division Multiplexing network, or a wireless network.

In Example 49, the subject matter of any one or more of Examples 40-48 optionally include the operations further comprising predicting a utilization of the second network based on the forecasted event, and overriding the designation of the second network in response to the predicted utilization meeting a criterion.

In Example 50, the subject matter of Example 49 optionally includes wherein the criterion is met when the predicted utilization is below a utilization threshold.

In Example 51, the subject matter of any one or more of Examples 49-50 optionally include the operations further comprising aggregating periodic utilization measurements of the second network, wherein the forecasting is based on the measurements.

In Example 52, the subject matter of any one or more of Examples 40-51 optionally include the operations further comprising sending data of the first class with an indication of the second network to a multiplexer in response to the overriding of the designation, the indication configured to cause the multiplexer to send the data of the first class over the second network.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory; etc.

We claim:

1. A system comprising
processing circuitry;
an electronic hardware memory storing instructions that, when executed by the processing circuitry, control the system to perform operations comprising:
designating a first network for a first class of traffic;
designating a second network for a second class of traffic;
routing the first and second classes of traffic according to the designation;
forecasting an event by accessing data in a data store, wherein the data store stores aggregated information indicating one or more of historical network usage information, news information, time and date information, social network information, and emergency management information; and
overriding the designation of the second network by routing the first class of traffic over the second network in response to the forecasted event.

2. The system of claim 1, the operations further comprising analyzing information in the data store to determine a cross correlation between a first time series indicating utilization of the second network and a second time series indicating the one or more of news information, time and date information, and social network information, and wherein the operations of forecasting the event comprises forecasting the event based on the cross correlation.

3. The system of claim 2, the operations further comprising detecting a cross correlation between utilization of the second network and a time series included in the aggregated information indicating particular dates; correlating the particular dates with future dates within a predetermined date window of a current date, and wherein the operations of forecasting the event comprises forecasting the event based on the correlating.

4. The system of claim 2, the operations further comprising detecting a cross correlation between first activity on a social network and utilization of the second network based on the aggregated information; detecting second activity on the social network, determining a similarity score between the first activity and the second activity, and forecasting the event based on the similarity score and the cross correlation between the first activity and the utilization of the second network.

5. The system of claim 2, the operations further comprising detecting a pattern in maintenance activity of the second network on particular dates based on the aggregated information; correlating the particular dates with other dates, the other dates with a predetermined data window of a current date, and forecasting the event based on the correlating.

6. The system of claim 1, the operations further comprising receiving weather information from a weather service, and forecasting the event based on the weather information.

7. The system of claim 1, the operations further comprising aggregating electric power service availability information, and forecasting the event based on the electric power service availability information.

8. The system of claim 1, wherein the first class of traffic is consumer traffic and the second class of traffic is enterprise traffic.

9. The system of claim 8, wherein the first network is an Internet Protocol network, a Time Division Multiplexing network, or a wireless network and the second network in an Internet Protocol network, a Time Division Multiplexing network, or a wireless network.

10. The system of claim 1, the operations further comprising predicting a utilization of the second network based on the forecasted event, and overriding the designation of the second network in response to the predicted utilization meeting a criterion.

11. The system of claim 10, wherein the criterion is met when the predicted utilization is below a utilization threshold.

12. The system of claim 10, the operations further comprising aggregating periodic utilization measurements of the second network, wherein the forecasting is based on the measurements.

13. The system of claim 1, the operations further comprising sending data of the first class with an indication of the second network to a multiplexer in response to the overriding of the designation, the indication configured to cause the multiplexer to send the data of the first class over the second network.

14. A system comprising
means for designating a first network for a first class of traffic;
means for designating a second network for a second class of traffic;
means for routing the first and second classes of traffic according to the designation;
means for forecasting an event by accessing data in a data store, wherein the data store stores aggregated information indicating one or more of historical network usage information, news information, time and date information, social network information, and emergency management information; and
means for overriding the designation of the second network by routing the first class of traffic over the second network in response to the forecasted event.

15. The system of claim 14, further comprising means for analyzing information in the data store to determine a cross correlation between a first time series indicating utilization of the second network and a second time series indicating the one or more of news information, time and date information, and social network information, and wherein the operations of forecasting the event comprises forecasting the event based on the cross correlation.

16. The system of claim 15, further comprising means for detecting a cross correlation between utilization of the second network and a time series included in the aggregated information indicating particular dates; correlating the particular dates with future dates within a predetermined date window of a current date, and wherein the operations of forecasting the event comprises forecasting the event based on the correlating.

17. A method, comprising:
designating a first network for a first class of traffic;
designating a second network for a second class of traffic;
routing the first and second classes of traffic according to the designation;
forecasting an event by accessing data in a data store, wherein the data store stores aggregated information indicating one or more of historical network usage information, news information, time and date information, social network information, and emergency management information; and
overriding the designation of the second network by routing the first class of traffic over the second network in response to the forecasted event.

18. The method of claim 17, further comprising analyzing information in the data store to determine a cross correlation between a first time series indicating utilization of the second network and a second time series indicating the one or more of news information, time and date information, and social network information, and wherein the operations of forecasting the event comprises forecasting the event based on the cross correlation.

19. The method of claim 18, further comprising detecting a cross correlation between utilization of the second network and a time series included in the aggregated information indicating particular dates; correlating the particular dates with future dates within a predetermined date window of a current date, and wherein the operations of forecasting the event comprises forecasting the event based on the correlating.

20. The method of claim 18, further comprising detecting a cross correlation between first activity on a social network and utilization of the second network based on the aggregated information; detecting second activity on the social network; determining a similarity score between the first activity and the second activity, and forecasting the event based on the similarity score and the cross correlation between the first activity and the utilization of the second network.
